(19) United States
(12) Patent Application Publication
(10) Pub. No.: US 2026/0295478 A1
(43) Pub. Date: Oct. 1, 2026

(54) DEVICE FOR CLEANING LIQUID MEDIA USING VACUUM BELT FILTERS

(71) Applicant: Matthias LEIPOLDT, Treuen (DE)

(72) Inventor: Matthias LEIPOLDT, Treuen (DE)

(21) Appl. No.: 19/631,786

(22) Filed: Mar. 27, 2026

(30) Foreign Application Priority Data
Mar. 29, 2025 (DE) 10 2025 001 325.6
Mar. 29, 2025 (DE) 20 2025 000 940.0

(51) Int. Cl. B01D 33/048; B01D 33/37; B01D 33/46; B01D 33/80

(52) U.S. Cl. CPC B01D 33/048; B01D 33/37; B01D 33/466; B01D 33/807

(57) ABSTRACT

The invention relates to an apparatus for cleaning liquid medium using vacuum belt filters, the apparatus having a container, assemblies with filter belts in connection with a vacuum pump, the assemblies each having rollers, the assemblies being arranged parallel or predominantly parallel and spaced obliquely from one another, and the first rollers arranged towards the base of the container being connected to the vacuum pump. The apparatus is characterized in particular in that the liquid medium is easy to clean for further use or application. In addition, the assemblies project above the surface of the medium to be cleaned. The rollers arranged above the surface of the medium to be cleaned are each coupled to drives. The deflection rollers are connected to each other via chain transmissions with link chains, the filter belts of the assemblies being detachably connected to the link chains. Channels are arranged spaced apart from the ends of the first deflection rollers, the legs of adjacent channels being connected to each other via plates. Furthermore, scraper plates are connected to the link chains.

The invention relates to an apparatus for cleaning liquid medium using vacuum belt filters, wherein
the apparatus has a container for receiving the medium, assemblies with filter belts as a vacuum belt filter, and at least one vacuum pump for generating a vacuum,
the assemblies each have rollers arranged in a row and spaced apart from each other for supporting the filter belt between supports, so that the respective circulating filter belt and the associated supports define a space,
the assemblies are arranged parallel or predominantly parallel and spaced obliquely from one another, and
the first rollers arranged towards the base of the container, as deflection rollers and hollow cylinders, have openings in their walls, at least in regions, and are connected via their interiors to the vacuum pump.

In a vacuum belt filter, also known as a vacuum filter, a vacuum pump generates a vacuum in a filter chamber, causing the liquid to be cleaned to pass through the filter belt, with contaminants remaining on the filter belt. The cleaned liquid is pumped out using a conveying apparatus.

Document DE 32 48 231 A1 discloses a vacuum filter system which is equipped with an endless conveyor belt. The conveyor belt is reinforced by high-tensile fabric inserts having, and provided with at least one longitudinally extending row of holes.

Document DE 20 2018 001 403 U1 discloses a vacuum belt filter for cleaning liquid medium, the vacuum belt filter having a container, an endless filter belt, and at least one vacuum pump for generating a vacuum. For this purpose, the container for receiving the medium has a guided filter belt that bridges the cross-section of the container, the filter belt being guided on rollers arranged in a row and spaced apart from each other, in the container for receiving the medium. Between the filter belt guided on the rollers, there is a cavity for cleaned medium, which is connected via a vacuum container, receiving the cleaned medium, in conjunction with the vacuum pump and a cleaned medium conveying apparatus. Furthermore, a unit extending the row of rollers, together with additional rollers guiding the filter belt, cuts through the surface of the medium to be cleaned, in the container. The vacuum belt filter has a filter belt that is guided in a meandering manner inside the container.

The document DE 10 2019 003 210 A1 discloses an apparatus for cleaning liquid medium using vacuum belt filters, the apparatus having a container for receiving the medium, filter belts, and at least one vacuum pump for generating a vacuum. The container also contains a plurality of supports, each having a filter belt. The supports each have rollers arranged in a row and spaced apart from each other for supporting the filter belt between rails, so that the respective circulating filter belt and the associated rails define a space. The filter belts are arranged parallel or predominantly parallel and obliquely spaced apart from each other, in the container. The rollers arranged towards the base of the container, as deflection rollers and hollow cylinders, have openings in their walls at least in regions, and are connected via their interiors to a vacuum chamber receiving a cleaned medium, in conjunction with a vacuum pump and a cleaned medium conveying apparatus. Furthermore, at least one of the supports, with the filter belt, cuts through the surface of the medium to be cleaned, in the container. The filter belt has a plurality of layers, a first layer being a band-shaped support element having holes, and at least a second layer being a filter fabric. The band-shaped support element has toothed belts. The feed forces are introduced via the toothed belts, resulting in not inconsiderable loads on the filter belts.

The invention specified in claim 1 is based on the object of easily cleaning liquid medium for further use or application.

This object is achieved by means of the features listed in claim 1.

The apparatus according to the invention for cleaning liquid medium using vacuum belt filters, wherein
the apparatus has a container for receiving the medium to be cleaned, assemblies with filter belts as a vacuum belt filter, and at least one vacuum pump for generating a vacuum,
the assemblies each have rollers arranged in a row and spaced apart from each other for supporting the filter belt between supports, so that the respective circulating filter belt and the associated supports define a space,
the assemblies are arranged parallel or predominantly parallel and spaced obliquely from one another,
the rollers arranged towards the base of the container, as first deflection rollers, are hollow cylinders having openings in their walls, and
the interiors of the first deflection rollers are connected to the vacuum pump as hollow cylinders,
   is characterized in particular in that liquid medium is easy to clean for further use or application.

Within the meaning of the invention, for this purpose the assemblies project beyond the surface of the medium to be cleaned, in the container, such that one end regions of the assemblies project beyond the surface of the medium to be cleaned, in the container, and the other end regions of the assemblies are arranged in the medium to be cleaned. According to the invention, the rollers pointing away from the medium to be cleaned and arranged above the surface of the medium to be cleaned, as second deflection rollers, are each coupled to drives as components of the assemblies, the second deflection rollers and the drives being arranged above the surface of the medium to be cleaned. Within the meaning of the invention, the deflection rollers are connected to each other via chain transmissions with link chains, the filter belts of the assemblies being detachably connected to the link chains. According to the invention, channels are arranged spaced apart from the ends of the first deflection rollers, in the medium to be cleaned, legs of adjacent channels being connected to each other via plates arranged spaced apart from the assemblies. Furthermore, within the meaning of the invention, scraper plates are connected to the link chains, the scraper plates being designed in such a way that the scraper plates can be guided through the spaces between the first deflection rollers, with the regions of the filter belts arranged thereon, and the channels, as well as between the plates and the regions of the assemblies spaced apart therefrom.

The assemblies with the filter belts are advantageously arranged obliquely, so that the respective upstream filter belt ends above the downstream one. Such an arrangement results in solids from the filter cake passing onto the respective downstream filter belt. The solids of the filter cake can be easily removed from the end of the row of successively arranged filter belts. Assemblies can be arranged inside the container or project beyond it. At least the last filter belt should end outside the container, so that the solids are easily transported out of the container. In the simplest case, the solids can easily fall off the last filter belt. In the spaces of the assemblies between the filter belts, a vacuum is applied via the openings of the deflection rollers, so that the medium to be cleaned is suctioned through the filter belts. By means of the assemblies with the filter belts, a large filter surface can thus be achieved for cleaning the liquid medium in the container.

The channels arranged spaced apart from the ends of the first deflection rollers, in the medium to be cleaned, and the plates connecting the legs of adjacent channels, can also be formed in one piece as a plate shaped in this way.

The deflection rollers are connected to each other via chain transmissions with link chains. For this purpose, at least the second deflection rollers have sprockets. The link chains are guided over the first deflection rollers. In one embodiment, the first deflection rollers can also have sprockets for the link chains.

The filter belts are detachably connected to the link chains. The filter belts are thus advantageously located between the driven link chains, so that the drive and synchronization of the filter belts is carried out by means of the link chains.

The feed forces are introduced into the filter belts at a plurality of points, via fastening elements on the link chains, resulting in low loads on the filter belts. The loads result from the number and therefore the spacing of the fastening elements of the filter belts. Furthermore, scraper plates are located on the link chains, so that the assemblies are each a combination of belt filter and container with scraper conveyor.

The filter belts are advantageously detachably connected to the link chains. In particular, the ends of the filter belts remain detachably connected to each other. The end regions of the assemblies, and thus the filter belts, project beyond the medium in the container. Furthermore, the filter belts are individually driven. This allows filter belts to be changed individually while the filters of the medium are running. The filtering process of the medium therefore does not need to be interrupted when changing filter belts.

The apparatus can thus be used particularly advantageously for cleaning liquid processing medium as the medium. Such processing operations can include, inter alia, machining, forming, or testing of objects. Of course, a liquid medium per se can also be cleaned.

Advantageous embodiments of the invention are set out in the following developments and embodiments. These can be used to develop the apparatus for cleaning liquid medium using vacuum belt filters, either individually or in combination.

In a development, the link chain can in partucular be roller chains.

In one embodiment, the roller chains can be detachably connected to the filter belts via tabs, the tabs being connected to bolts of the roller chains. The tabs can in particular be shaped like fingers, and thus be connected to the filter belts.

For this purpose, the tab is advantageously connected to the bolt of the link chain. The tab can be flat or U-shaped in cross-section.

The detachable connections between the filter belts and the roller chains are, in embodiments, clamping and/or screw connections.

In one embodiment, the rollers of the roller chains can be rollers guided on rails as components of the support. For this purpose, the rails can be simple plates on which the rollers can roll.

In embodiments, the scraper plates can be smooth or have serrations. Scraper plates with serrations are particularly advantageous when cleaning the processing medium for processing steel, where a floating wool of steel chips forms. The developing wool carpet is transported out of the container with an alternating arrangement of serrated and smooth scraper plates.

In a development, the channels can be semicircular channels, so that the solids can be transported away largely completely. Dead spaces are largely avoided.

In one embodiment, the interiors of the first deflection rollers are connected via a vacuum container receiving a cleaned medium, in conjunction with the vacuum pump and a cleaned medium conveying apparatus. The cleaned liquid medium located between the filter belts is pumped out via the vacuum container and the conveying apparatus. The pumping out of the cleaned medium, combined with the vacuum of the vacuum pump, creates a flow in the container.

In one embodiment, the vacuum container can contain at least one fill level sensor connected to a control apparatus. The control apparatus is connected to the vacuum pump and the apparatus that conveys the cleaned medium.

This enables continuous operation of the vacuum belt filter. At the same time, the ingress of cleaned medium into the vacuum pump can be prevented.

In one embodiment, the last assembly can project both beyond the surface of the medium to be cleaned, in the container, and laterally beyond the container. At least the last assembly can have a device for removing solids as contaminants. Beneath the lateral projection, there may be another container for receiving the contaminants of the medium to be cleaned, which fall off from the last assembly and/or by means of the device for removing solids.

An embodiment of the invention is shown in principle in each of the drawings and is described in more detail below.

In the Drawings:

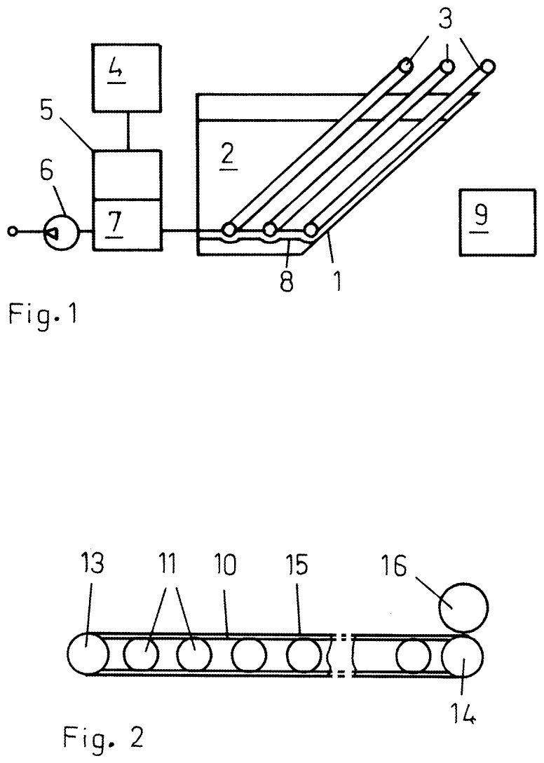

FIG. 1 shows an apparatus for cleaning liquid mediums using vacuum belt filters,

FIG. 2 shows a sectional side view of an assembly,

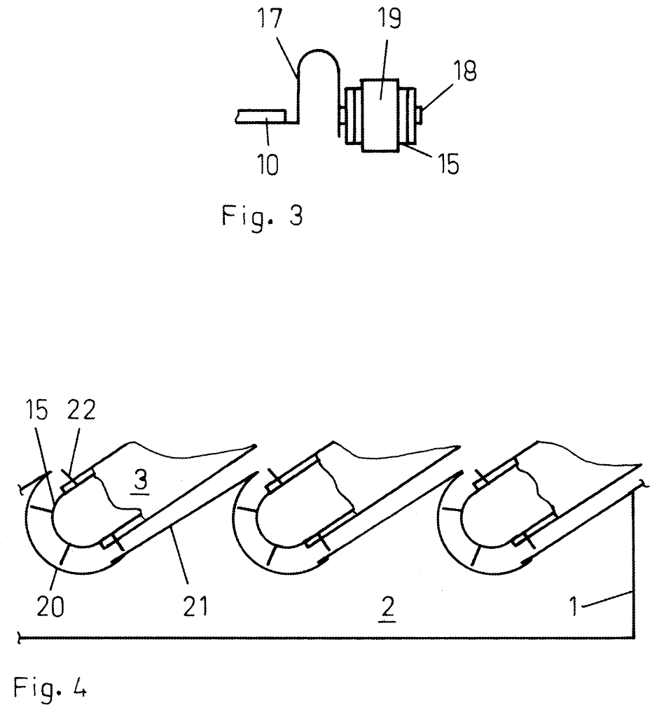

FIG. 3 shows a roller chain with a filter belt, and

FIG. 4 shows end regions of assemblies in a container.

A apparatus for cleaning liquid medium 2 using vacuum belt filters essentially consists of a container 1 with medium 2 to be cleaned, a vacuum pump 4, a vacuum container 5, an apparatus 6 for conveying cleaned medium 7, a further container 9 for receiving contaminants, and assemblies 3 with rollers 11, filter belts 10 and drives 16.

FIG. 1 shows a schematic view of an apparatus for cleaning liquid medium 2 using vacuum belt filters.

The assemblies 3 are arranged parallel or predominantly parallel and spaced obliquely from one another. The assemblies 3 are connected via the vacuum container 5, the apparatus 6 conveying cleaned medium 7, such that cleaned medium 7 is made available for further use. The assemblies 3 cut through and project beyond the surface of the medium 2 to be cleaned, in the container 1, one end of the last assembly 3 being located outside the container 1. The further container 9 for receiving filtered-out contaminants is arranged below this end. The vacuum container 5 is connected to the vacuum pump 4. Furthermore, this contains at least one fill level sensor which is connected to a control apparatus which is also connected to the vacuum pump 4 and the apparatus 6 conveying the cleaned medium. Among the assemblies 3 is a base 8, which can be the base of the container 1 or an intermediate base 8 in the container 1.

FIG. 2 shows a schematic sectional side view of an assembly 3.

An assembly 3 as a vacuum belt filter has the filter belt 10 on the rollers 11 arranged in a row and spaced apart from each other between supports 12, so that the circulating filter belt 10 and the supports 12 define a space. The roller 11 of the row, which points towards the bottom of the container 1 and is arranged in the medium 2 to be cleaned, is a hollow cylinder with openings in its wall and is the first deflection roller. The interior of this first deflection roller is connected to the vacuum pump 4. The first deflection roller 11 can still be connected to first sprockets 13. The last roller 11 of the row, arranged outside the medium 2 to be cleaned, is a second deflection roller that is connected to sprockets or second sprockets 14. A sprocket or second sprocket 14 connected to the second deflection roller is connected to a drive 16. Thus, in a first embodiment, the first sprockets 13 and the second sprockets 14 are connected to each other via link chains 15, thus forming the chain transmission as chain drives. Thus, in a second embodiment, the sprockets and the first deflection roller are connected to each other via link chains 15. In this case, the link chains 15 are guided over the second deflection roller, so that chain transmissions are formed. The link chains 15 are in particular roller chains 15.

FIG. 3 shows a schematic view of a roller chain 15 with a filter belt 10.

Each of the roller chains 15 is detachably connected to the filter belts 10 via tabs 17. For this purpose, the tabs are spaced apart from each other and connected to bolts 18 of the roller chains 15. The detachable connections between the filter belts 10 and the roller chains 15 are clamping and/or screw connections. The rollers 19 of the roller chains 15 are guided on rails as components of the supports 12.

FIG. 4 shows a schematic view of end regions of assemblies 3 in a container 1.

Two semicircular channels 20 are arranged in the medium 2 to be cleaned, spaced apart from the ends of the first deflection rollers. Legs of adjacent channels 20 are connected to each other via plates 21 arranged spaced apart from the assemblies 3. The channels 20 and the plates 21 form the intermediate base 8 in the container 1 or are the base of the container 1. Scraper plates 22 are also connected to the roller chains 15. In this case, the scraper plates 22 are designed in such a way that the scraper plates 22 can be guided through the spaces between the first deflection rollers, with the regions of the filter belts 10 arranged thereon, and the channels 20, as well as between the plates 21 and the regions of the assemblies 3 arranged spaced apart therefrom. The scraper plates 22 are either smooth or have serrations.

In one embodiment, the last assembly 3, which projects both beyond the surface of the medium 2 to be cleaned, in the container 1, and laterally beyond the container 1, may have a device for removing solids. In addition, a further container 9 can be located under the lateral projection, to receive the contaminants falling from the last assembly 3 and/or by means of the device for removing contaminants from the medium 2 to be cleaned.

1. Apparatus for cleaning liquid medium (2) using vacuum belt filters, wherein
the apparatus has a container (1) for receiving the medium (2) to be cleaned, assemblies (3) with filter belts (10) as a vacuum belt filter, and at least one vacuum pump (4) for generating a vacuum,
the assemblies (3) each have rollers (11) arranged in a row and spaced apart from each other for supporting the filter belt (10) between supports (12), so that the respective circulating filter belt (10) and the associated supports (12) define a space,
the assemblies (3) are arranged parallel or predominantly parallel and spaced obliquely from one another,
the rollers (11) arranged towards the bottom of the container (1) are hollow cylinders with openings in their walls, as first deflection rollers, and
the interiors of the first deflection rollers are connected to the vacuum pump (4) as hollow cylinders,
wherein
the assemblies (3) project above the surface of the medium (2) to be cleaned, in the container (1),
the rollers (11) pointing away from the medium (2) to be cleaned and arranged above the surface of the medium (2) to be cleaned are each coupled, as second deflection rollers, to drives (16) as components of the assemblies (3), the second deflection rollers and the drives (16) being arranged above the surface of the medium (2) to be cleaned,
the deflection rollers are connected to each other via chain transmissions with link chains (15),
the filter belts (10) of the assemblies (3) are detachably connected to the link chains (15),
channels (20) are arranged spaced apart from the ends of the first deflection rollers, in the medium (2) to be cleaned, legs of adjacent channels (20) being connected to each other via plates (21) arranged spaced apart from the assemblies (3),
scraper plates (22) are connected to the link chains (15), and
the scraper plates (22) are designed in such a way that the scraper plates (22) can be guided through the spaces between the first deflection rollers, with the regions of the filter belts

(10) arranged on them, and the channels (20), as well as between the plates (21) and the regions of the assemblies (3) arranged at spaced apart therefrom.

2. The apparatus according to claim 1, wherein the link chains (15) are roller chains (15).

3. The apparatus according to claim 1, wherein the roller chains (15) are detachably connected to the filter belts (10) via tabs (17), and that the tabs (17) are connected to bolts (18) of the roller chains (15).

4. The apparatus according to claim 1, wherein the detachable connections between the filter belts (10) and the roller chains (15) are clamping and/or screw connections.

5. The apparatus according to claim 1, wherein the rollers (19) of the roller chains (15) are rollers (19) that are guided on rails as components of the supports (12).

6. The apparatus according to claim 1, wherein the scraper plates (22) are smooth or that the scraper plates (22) have serrations.

7. The apparatus according to claim 1, wherein the channels (20) are semicircular channels (20).

8. The apparatus according to claim 1, wherein the interiors of the first deflection rollers are connected via a vacuum container (5), receiving a cleaned medium (7), in conjunction with the vacuum pump (4) and an apparatus (6) conveying a cleaned medium (7).

9. The apparatus according to claim 1, wherein at least one fill level sensor connected to a control apparatus is located in the vacuum container (5), and that the control apparatus is connected to the vacuum pump (4) and the apparatus (6) conveying the cleaned medium (7).

10. The apparatus according to claim 1, wherein the last assembly (3) projects laterally over both the surface of the medium (2) to be cleaned in the container (1) and the container (1), that at least the last assembly (3) has a device for removing solids, and that a further container (9) for receiving the contaminants of the medium (2) to be cleaned falling off the last assembly (3) and/or by means of the device for removing solids is located below the lateral projection.

11. The apparatus according to claim 2, wherein the roller chains (15) are detachably connected to the filter belts (10) via tabs (17), and that the tabs (17) are connected to bolts (18) of the roller chains (15).

12. The apparatus according to claim 11, wherein the detachable connections between the filter belts (10) and the roller chains (15) are clamping and/or screw connections.

13. The apparatus according to claim 12, wherein the rollers (19) of the roller chains (15) are rollers (19) that are guided on rails as components of the supports (12).

14. The apparatus according to claim 13, wherein the scraper plates (22) are smooth or that the scraper plates (22) have serrations.

15. The apparatus according to claim 13, wherein the scraper plates (22) are smooth.

16. The apparatus according to claim 13, wherein the scraper plates (22) have serrations.

17. The apparatus according to claim 14, wherein the channels (20) are semicircular channels (20).

18. The apparatus according to claim 17, wherein the interiors of the first deflection rollers are connected via a vacuum container (5), receiving a cleaned medium (7), in conjunction with the vacuum pump (4) and an apparatus (6) conveying a cleaned medium (7).

19. The apparatus according to claim 18, wherein at least one fill level sensor connected to a control apparatus is located in the vacuum container (5), and that the control apparatus is connected to the vacuum pump (4) and the apparatus (6) conveying the cleaned medium (7).

20. The apparatus according to claim 19, wherein the last assembly (3) projects laterally over both the surface of the medium (2) to be cleaned in the container (1) and the container (1), that at least the last assembly (3) has a device for removing solids, and that a further container (9) for receiving the contaminants of the medium (2) to be cleaned falling off the last assembly (3) and/or by means of the device for removing solids is located below the lateral projection.
